(19) United States
(12) Patent Application Publication
(10) Pub. No.: US 2026/0011964 A1
(43) Pub. Date: Jan. 8, 2026

(54) Light string connector

(71) Applicant: JOININ GLOBAL PTE.LTD., SG (SG)

(72) Inventor: Hongbing ZHENG, Hangzhou (CN)

(73) Assignee: JOININ GLOBAL PTE.LTD., SG (SG)

(21) Appl. No.: 18/823,746

(22) Filed: Sep. 4, 2024

(30) Foreign Application Priority Data
Jul. 2, 2024 (CN) 2024215498165

(51) Int. Cl. H01R 25/00; F21S 4/10

(52) U.S. Cl. CPC H01R 25/003; F21S 4/10

(57) ABSTRACT

A light string connector comprises a wire housing box, a male power terminal, and one or more female power terminals for supplying power to the light strings. The male power terminal and the female power terminals are electrically connected within the wire housing box. The light string connector features a structural design that includes the wire housing box, the male power terminal, and multiple female power terminals, enabling the assembly and connection of multiple light strings. Each female power terminal operates independently, allowing individual or collective power supply to one, some, or all of the light strings connected to the female power terminals. This effectively resolves the issue that each light string requires a separate power connection at its free end.

### FIELD OF THE INVENTION

The present disclosure relates to the technical field of lighting installation, and in particular to a light string connector.

### BACKGROUND OF THE INVENTION

LED light strings are widely used as a kind of lighting fixture, and each light string has a male connector at one end and a female connector at the other end. Currently, connectors that include a male end and a female end are typically used to connect LED light strings. Specifically, when two light strings are connected, they form a series connection shown as follows: the female connector of the first light string-the male end of the connector-the female end of the connector-the male connector of the second light string.

Sometimes, multiple light strings need to be installed in a radial pattern. However, the current approach requires connecting the ends of light strings to separate power sources or outlets, and there is no convenient fixation structure at the central junction where these light strings converge.

### SUMMARY OF THE INVENTION

The present disclosure provides a light string connector, the light string connector comprises a wire housing box, a male power terminal, and one or more female power terminals for supplying power to the light strings. The male power terminal and the female power terminals are electrically connected within the wire housing box.

In an embodiment, the wire housing box comprises a bottom surface, a top surface, and a side surface located between the bottom surface and the top surface, wherein the side surface comprises multiple sub-side surfaces, and each two adjacent sub-side surfaces are connected.

In an embodiment, the male power terminal and/or the female power terminals are positioned on the side surface of the wire housing box.

In an embodiment, the male power terminal and the female power terminals are respectively positioned on different sub-side surfaces of the wire housing box, and the female power terminals can be positioned on the same sub-side surface or on different sub-side surfaces.

In an embodiment, the light string connector further comprises a power cord, and the side surface of the wire housing box is provided with a power cord hole. The first end of the power cord is connected inside the wire housing box to the female power terminals, and the second end of the power cord passes through the power cord hole and connects to the male power terminal.

In an embodiment, a power cord guide is provided along the circumference of the power cord hole, extending axially along the power cord hole.

In an embodiment, the wire housing box further comprises one or more power supply lines, and the side surface of the wire housing box is provided with one or more power supply line holes. The first end of each of the power supply lines is connected inside the wire housing box to the male power terminal, and the second end of each of the power supply lines passes through one power supply line hole and connects to one of the female power terminals.

In an embodiment, the power supply line holes are positioned on the same sub-side surface or on different sub-side surfaces.

In an embodiment, one power supply line guide is provided along the circumference of each of the power supply line holes, extending axially along each of the power supply line holes.

In an embodiment, the wire housing box is provided with a connection hole; the connection hole is located on the bottom surface, the top surface, or extends through both the bottom and top surfaces.

In an embodiment, multiple light bodies are sequentially arranged along each of the power supply lines.

In an embodiment, the light bodies are connected to one of the power supply lines through a buckle and rotate around a pivot axis.

In an embodiment, a suspension member is positioned on each of the power supply lines near a corresponding female power terminal, and the suspension member is provided with a hanging hole.

As described above, the light string connector described in the present disclosure has the following beneficial effects.

1. The light string connector in the present disclosure features a structural design that includes a wire housing box, a male power terminal, and multiple female power terminals, enabling the assembly and connection of multiple light strings. Each female power terminal operates independently, allowing individual or collective power supply to one, some, or all of the light strings connected to the female power terminals. This effectively resolves the issue in existing technologies where each light string requires a separate power connection at its free end.

2. In the present disclosure, multiple sub-side surfaces of the wire housing box feature wire pass-through holes or fixed female terminals, allowing for the assembly of light strings at certain angles, which facilitates easier and more efficient formation of net-like light string layouts.

3. In the present disclosure, the male power terminal and/or female power terminal can be directly fixed on the wire housing box or positioned outside the box via wires, providing the light string connector with multiple connection methods to the light strings, thereby enhancing the connector's flexibility and applicability in various scenarios.

4. In the present disclosure, multiple light bodies can be sequentially arranged along the power supply line, allowing the light string connector to be integrated with the light bodies into a single structure, with the light bodies being capable of rotating and hanging independently.

### BRIEF DESCRIPTION OF DRAWINGS

FIG. 1 shows a structural schematic diagram of a light string connector according to an embodiment of the present disclosure.

FIG. 2 shows a schematic diagram of one configuration mode of a power cord hole and power supply line holes on sub-side surfaces of a wire housing box of the light string connector according to an embodiment of the present disclosure.

FIG. 3 shows a side view of the light string connector according to the embodiment of the present disclosure as depicted in FIG. 2.

FIG. 4 shows a schematic diagram of another configuration mode of the power cord hole and power supply line holes on the sub-side surfaces of the wire housing box of the light string connector according to an embodiment of the present disclosure.

FIG. 5 shows a schematic diagram of light bodies connected to power supply lines of the wire housing box of the light string connector according to an embodiment of the present disclosure.

### REFERENCE NUMERALS

100 Light string connector
110 Wire housing box
111 Sub-side surface
112 Power supply line guide
113 Power cord guide
114 Connection hole
120 Male power terminal
121 Power cord
130 Female power terminal
131 Power supply line
140 Light body
141 Suspension member

### DETAILED DESCRIPTION OF THE INVENTION

The following description provides further details of the present disclosure with reference to the accompanying drawings, but the scope of the present disclosure is not limited to the descriptions below.

The embodiments of the present disclosure are illustrated through specific examples, and those skilled in the art can easily understand other advantages and effects of the present disclosure based on the content disclosed herein. The present disclosure can also be implemented or applied through other different specific embodiments, and the details provided in this description can be modified or altered in various ways without departing from the spirit of the present disclosure, depending on different perspectives and applications. It should be noted that, where there is no conflict, the following embodiments and the features within these embodiments may be combined with each other.

It should also be noted that the illustrations provided in the following embodiments are only schematic to illustrate the basic concept of the present disclosure. Therefore, the figures only show the components relevant to the present disclosure and are not drawn according to the actual number, shape, or size of the components as implemented. The type, number, and proportions of the components in actual implementation can be changed arbitrarily, and the component layout may be more complex.

The light string connector provided in the following embodiments of the present disclosure is a connector that is at the junction of multiple light strings and facilitates the assembly of multiple light strings, addressing the issue of each light string requiring a separate power connection at its free end.

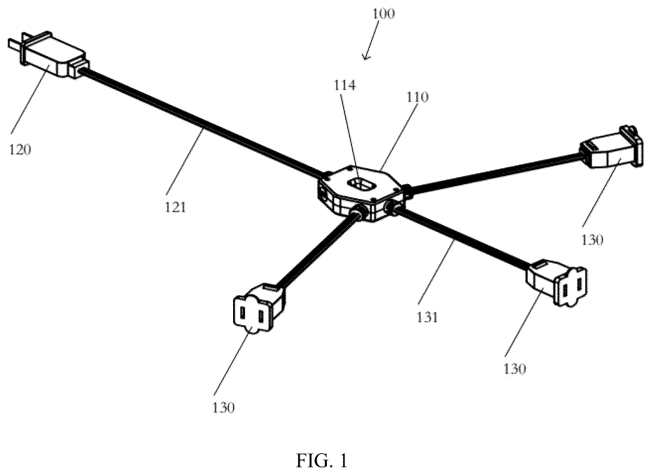

As shown in FIGS. 1 to 5, the present disclosure provides a light string connector 100. Through the structural design of the wire housing box 110, the male power terminal 120, and multiple female power terminals 130, the connector can simultaneously assemble and connect multiple light strings and provide power to them partly or collectively through the female power terminals 130. That is each light string can be powered individually, enabling the connector to be used in combination with the light strings without affecting their ability to be used separately, effectively addressing the issue in existing technologies where each light string requires a separate power connection at its free end. In the present disclosure, the male power terminal 120 and/or the female power terminals 130 can be directly fixed to the wire housing box 110 or arranged outside the wire housing box 110 via wires, providing the light string connector 100 with multiple connection methods to the light strings, thereby enhancing the connector's flexibility and applicability in various scenarios. Multiple light bodies 140 can be sequentially arranged on the power supply line 131, allowing the light string connector 100 to be integrated with the light bodies into a single structure, with the light bodies 140 capable of rotating and hanging independently.

The following will describe in detail the implementation and the principle of the light string connector 100 of the present disclosure in conjunction with FIGS. 1 to 5.

FIG. 1 shows a structural schematic diagram of a light string connector 100 according to an embodiment of the present disclosure. As shown in FIG. 1, in this embodiment, the light string connector 100 includes a wire housing box 110, a male power terminal 120, and multiple female power terminals 130 for supplying power to the light strings. The male power terminal 120 and the female power terminals 130 are electrically connected to each other within the wire housing box 110.

In this embodiment, the wire housing box 110 integrates the male power terminal 120 and multiple female power terminals 130. The multiple female power terminals 130 are electrically connected to the male power terminal 120 inside the wire housing box 110, allowing a single male power terminal 120 to supply power to multiple female power terminals 130 simultaneously. This configuration enables each female power terminal 130 to supply power to one light string independently, thus eliminating the need for each light string to be separately connected to a power source at its free end.

In this embodiment, the light string connector 100, through the structural design of the wire housing box 110, the male power terminal 120, and the multiple female power terminals 130, allows for the simultaneous assembly and connection of multiple light strings. Each female power terminal 130 operates independently, allowing multiple light strings to be powered individually. This design allows the connector to be used in combination with the light strings without affecting their ability to be used separately, effectively addressing the issue in existing technologies where each light string requires a separate power connection at its free end.

In one specific implementation of this embodiment, the wire housing box 110 includes a bottom surface, a top surface, and a side surface between the bottom and top surfaces, with the side surface comprising multiple sub-side surfaces 111, wherein each two adjacent sub-side surfaces are connected.

In this embodiment, the bottom surface, top surface, and side surface of the wire housing box 110 form a sealed, hollow space, with the internal hollow space of the wire housing box used for the electrical connection between the male power terminal 120 and the female power terminals 130. This means that the electrical connections between the male power terminal 120 and the female power terminals 130 are located inside the wire housing box 110, providing both an aesthetically pleasing appearance and protection for the wiring of the male power terminal 120 and female power terminals 130.

In this embodiment, the side surface of the wire housing box 110 includes multiple sub-side surfaces 111, wherein each two adjacent sub-side surfaces are connected and each sub-side surface 111 is a flat plane. This design facilitates the connection of the wire housing box 110 with each of the male power terminals 120 and the female power terminals 130.

In this embodiment, the male power terminal 120 and/or the female power terminals 130 can be directly fixed to the wire housing box 110 or positioned outside the wire housing box 110 via wires, providing the light string connector 100 with multiple connection methods to the light strings. This enhances the flexibility of the light string connector 100 and its applicability in various scenarios. The following explains the connection between the wire housing box 110 and the male power terminal 120, as well as the female power terminals 130.

In one specific implementation of this embodiment, the male power terminal 120 and/or the female power terminals 130 are fixed to the side surface of the wire housing box 110.

In other words, in this embodiment, the male power terminal 120 may be fixed to the side surface of the wire housing box 110, or the female power terminals 130 may be fixed to the side surface of the wire housing box 110, or both the male power terminal 120 and the female power terminals 130 may be fixed to the side surface of the wire housing box 110.

When the male power terminal 120 and/or the female power terminals 130 are fixed to the side surface of the wire housing box 110, they can be integrally formed with the wire housing box 110 through injection molding, or they can be directly fixed to the side surface of the wire housing box 110 using methods such as welding, screws, etc.

When the male power terminal 120 and/or the female power terminals 130 are fixed to the side surface of the wire housing box 110, the male power terminal 120 and the female power terminals 130 are positioned on different sub-side surfaces 111 of the wire housing box 110. The female power terminals 130 may all be arranged on the same sub-side surface 111 or on different sub-side surfaces 111.

Specifically, in this embodiment, the male power terminal 120 is positioned on one sub-side surface 111, while the female power terminals 130 are positioned on the remaining sub-side surfaces 111. A single sub-side surface 111 can be provided with one female power terminal 130 or multiple female power terminals 130. When multiple female power terminals 130 are positioned on one sub-side surface 111, they can be arranged side by side in parallel, or in a pattern array, for example, three female power terminals 130 can be arranged in parallel or in a triangular configuration, etc.

If the male power terminal 120 is not directly positioned on the sub-side surface 111 of the wire housing box 110, the male power terminal 120 is positioned outside the wire housing box 110 via a wire, and the wire is connected to the female power terminals 130 within the wire housing box 110.

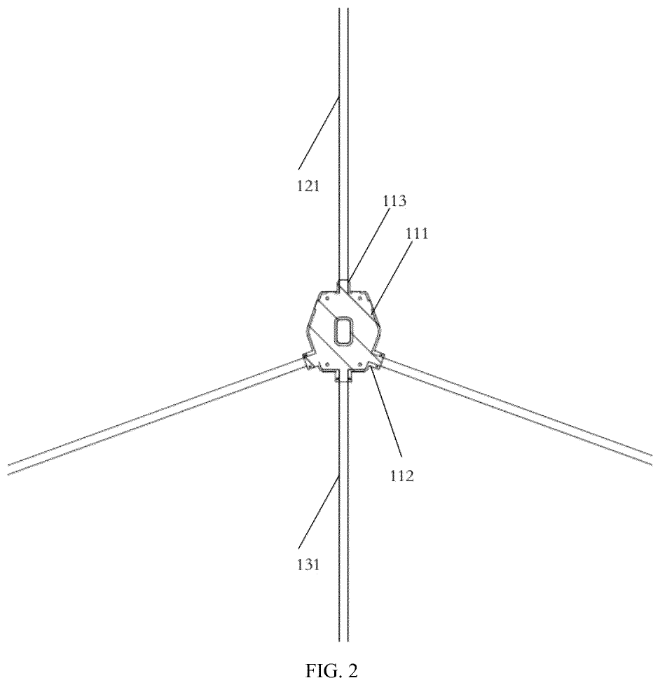

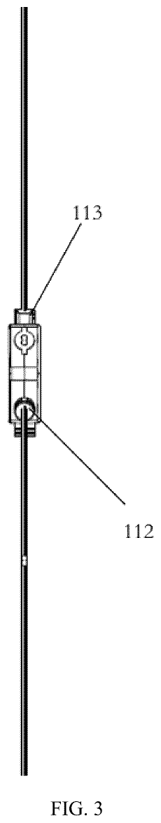

FIG. 2 shows a schematic diagram of one configuration mode of a power cord hole and power supply line holes on sub-side surfaces 111 of the wire housing box 110 of the light string connector 100 according to an embodiment of the present disclosure. FIG. 3 shows a side view of the light string connector 100 according to the embodiment of the present disclosure as depicted in FIG. 2. Specifically, as shown in FIGS. 2 and 3, in one specific implementation of this embodiment, the light string connector 100 further includes a power cord 121. A power cord hole is provided on the side surface of the wire housing box 110; a first end of the power cord 121 is connected to the female power terminals 130 inside the wire housing box 110, and a second end of the power cord 121 passes through the power cord hole and connects to the male power terminal 120.

In one embodiment, the male power terminal 120 can be positioned outside the wire housing box 110. The first end of the power cord 121 is connected to the female power terminals 130 inside the wire housing box 110, while the second end of the power cord 121 passes through the power cord hole on the wire housing box 110 and connects to the male power terminal 120 positioned outside the wire housing box 110. Since the male power terminal 120 is connected to the wire housing box 110 via the power cord 121, it facilitates drawing power from a source located at a certain distance from the wire housing box 110.

In one specific implementation of this embodiment, as shown in FIGS. 2 and 3, a power cord guide 113 is provided along the circumference of the power cord hole, extending axially along the power cord hole. The power cord guide 113 allows the power cord 121 to smoothly pass through the wire housing box 110 and also ensures a more secure fixation of the power cord 121 at the power cord hole, providing better protection for the power cord 121 by preventing it from moving or bending at the power cord hole.

In this embodiment, for the multiple female power terminals 130, all of them may be directly positioned on the sub-side surfaces 111 of the wire housing box 110, or some of them may be directly positioned on the sub-side surfaces 111 of the wire housing box 110, while the remaining female power terminals 130 may be positioned outside the wire housing box 110 via wires. Alternatively, all the female power terminals 130 may be positioned outside the wire housing box 110 via wires.

In this embodiment, when one or more of the female power terminals 130 are not directly positioned on the sub-side surfaces 111 of the wire housing box 110, they are positioned outside the wire housing box 110 via wires, and these wires are connected to the male power terminal 120 inside the wire housing box 110.

Specifically, in one specific implementation of this embodiment, the light string connector 100 further includes at least one power supply line 131, and at least one power supply line hole is provided on the side surface of the wire housing box 110. A first end of the power supply line 131 is connected to the male power terminal 120 inside the wire housing box 110, while a second end of the power supply line 131 passes through the power supply line hole and connects to one female power terminal 130.

In one embodiment, the female power terminals 130 can be positioned outside the wire housing box 110. The first end of the power supply line 131 is connected to the male power terminal 120 inside the wire housing box 110, while the second end of the power supply line 131 passes through the power supply line hole on the wire housing box 110 and connects to one female power terminal 130 positioned outside the wire housing box 110. Since each of the female power terminals 130 is connected to the wire housing box 110 via one power supply line 131, it facilitates connecting to the light strings when there is a certain distance between the installation position of the wire housing box 110 and the light strings.

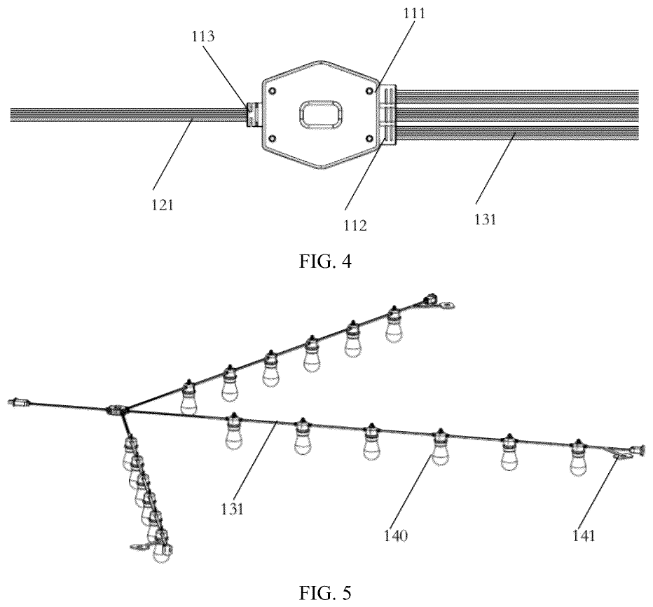

In one specific implementation of this embodiment, the power supply line holes are either all positioned on the same sub-side surface 111 or on different sub-side surfaces 111. In this embodiment, the power cord hole is positioned on one sub-side surface 111, while the remaining sub-side surfaces 111 are provided with the power supply line holes. As shown in FIGS. 2 and 3, a single sub-side surface 111 can be equipped with one power supply line hole, or, as shown in FIG. 4, it can be equipped with multiple power supply line holes. When multiple power supply line holes are positioned on one single sub-side surface 111, they can be arranged side by side in parallel or in a pattern array. For example, three power supply line holes can be arranged in a parallel configuration or in a triangular configuration.

In one specific implementation of this embodiment, as shown in FIGS. 2 to 4, a power supply line guide 112 is provided along the circumference of the power supply line hole, extending axially along the power supply line hole. The power supply line guide 112 allows the power supply line 131 to pass smoothly through the wire housing box 110, ensuring a more secure fixation of the power supply line 131 at the power supply line hole, providing better protection for the power supply line 131 by preventing it from moving or bending at the power supply line hole.

In this embodiment, the male power terminal 120 and/or the female power terminal 130 can be directly fixed to the wire housing box 110 or positioned outside the wire housing box 110 via wires, providing the light string connector 100 with multiple connection methods to the light strings, thereby enhancing the connector's flexibility and applicability in various scenarios.

Additionally, in the present disclosure, the multiple sub-side surfaces of the wire housing box 110 feature wire pass-through holes or fixed female terminals, supporting the assembly of light strings at certain angles and making the arrangement of net-like light strings more convenient and efficient.

In one specific implementation of this embodiment, a connection hole 114 is provided on the wire housing box 110, which is used for hanging the light string connector 100. The connection hole 114 can be positioned on the bottom surface, the top surface, or extends through both the bottom and top surfaces.

Furthermore, in this embodiment, the light string connector 100, in addition to connecting to light strings via the female power terminals 130, can also connect directly to the light bodies through the power supply line 131.

FIG. 5 shows a schematic diagram of the light bodies 140 connected to the power supply line 131 of the wire housing box 110 of the light string connector 100 according to an embodiment of the present disclosure. Specifically, as shown in FIG. 5, in one specific implementation of this embodiment, multiple light bodies 140 are sequentially arranged along each power supply line 131. In this way, the light bodies and the light string connector 100 form an integrated structure, making the light string connector 100 itself includes the light strings. The number of light bodies 140 arranged on the power supply line 131 can be adjusted and determined based on the actual space and decorative needs.

In this embodiment, the light bodies 140 are connected to the power supply line 131 through a buckle mechanism and rotate around a pivot axis. The buckle mechanism allows for quick assembly and disassembly of the light bodies 140 without the need for additional tools. For the connection between the power supply line 131 and each light body 140, the buckle mechanism enables the light bodies 140 to be quickly installed and removed without tools, simplifying the operation process, reducing maintenance costs to some extent, and greatly facilitating daily use and maintenance.

In one specific implementation of this embodiment, a suspension member 141 is positioned on the power supply line 131 near one female power terminal 130, and the suspension member 141 is equipped with a hanging hole, making it easier to hang and secure the light strings. The size and shape of the hanging hole are determined based on the number of light bodies 140, and the size and shape of the object to be hung, ensuring the stability of the light string connector and preventing it from slipping.

As can be seen, in this embodiment, multiple light bodies 140 can be sequentially arranged along the power supply line 131 of the light string connector 100, allowing the light string connector 100 to integrate with the light bodies into a single structure, making the light string connector 100 itself forming multiple light strings. The light bodies 140 can rotate and hang independently, greatly facilitating daily use and maintenance.

In summary, the light string connector provided by the present disclosure, through the structural design of the wire housing box, the male power terminal, and multiple female power terminals, allows for the simultaneous assembly and connection of multiple light strings. Each female power terminal operates independently, allowing individual or collective power supply to one, some, or all of the light strings connected to the female power terminals. This effectively resolves the issue in existing technologies where each light string requires a separate power connection at its free end. The multiple sub-side surfaces of the wire housing box feature wire pass-through holes or fixed female terminals, allowing for the assembly of light strings at certain angles, which facilitates easier and more efficient formation of net-like light string layouts. The male power terminal and/or female power terminal can be directly fixed on the wire housing box or positioned outside the box via wires, providing the light string connector with multiple connection methods to the light strings, thereby enhancing the connector's flexibility and applicability in various scenarios. The multiple light bodies can be sequentially arranged along the power supply line, allowing the light string connector to be integrated with the light bodies into a single structure, with the light bodies being capable of rotating and hanging independently.

The above embodiments only illustrate the principles and effectiveness of the present disclosure and are not intended to limit it. Anyone familiar with this technology may modify or change the above embodiment without violating the spirit and scope of the present disclosure. Therefore, all equivalent modifications or changes completed by those skilled in the art within the spirit and technical ideas disclosed in the present disclosure shall still be covered by the claims of the present disclosure.

1. A light string connector, comprising a wire housing box, a male power terminal, and one or more female power terminals for supplying power to light strings;
wherein the male power terminal and the one or more female power terminals are electrically connected;
the light string connector further comprises one or more power supply lines, wherein a side surface of the wire housing box is provided with one or more power supply line holes;
a first end of each of the one or more power supply lines is connected to the male power terminal, and a second end of each of the one or more power supply lines passes through a corresponding one of the one or more power supply line holes and connects to a corresponding one of the one or more female power terminals;
wherein one power supply line guide is provided along the circumference of each of the one or more power supply line holes, extending axially along a corresponding one of the one or more power supply line holes;
wherein when the light strings are connected to the one or more female power terminals, the one or more female power terminals supply power to the light strings;
wherein the light string connector further comprises multiple light bodies sequentially arranged along each of the one or more power supply lines, and the light bodies and the light string connector form an integrated structure;
wherein the light bodies are connected to each of the one or more power supply lines through a buckle, and each of the light bodies rotates around a pivot axis of the respective light body.

2. The light string connector according to claim 1, wherein the wire housing box comprises a bottom surface, a top surface, and a side surface located between the bottom surface and the top surface, wherein the side surface comprises multiple sub-side surfaces, and each two adjacent sub-side surfaces are connected.

3. The light string connector according to claim 2, wherein the male power terminal and/or the one or more female power terminals are positioned on the side surface of the wire housing box.

4. The light string connector according to claim 3, wherein the male power terminal and the one or more female power terminals are respectively positioned on different sub-side surfaces of the wire housing box, and if the one or more female power terminals are provided in plurality, the female power terminals are positioned on the same sub-side surface or on different sub-side surfaces.

5. The light string connector according to claim 2, further comprising a power cord, wherein the side surface of the wire housing box is provided with a power cord hole;
a first end of the power cord is connected to the one or more female power terminals, and a second end of the power cord passes through the power cord hole and connects to the male power terminal.

6. The light string connector according to claim 5, wherein a power cord guide is provided along the circumference of the power cord hole, extending axially along the power cord hole.

7. (canceled)

8. The light string connector according to claim 1, wherein when the one or more power supply line holes are provided in plurality, the power supply line holes are positioned on the same sub-side surface or each of the power supply line holes is positioned on a different sub-side surface from another power supply line holes.

9. (canceled)

10. The light string connector according to claim 2, wherein the wire housing box is provided with a connection hole; the connection hole is located on the bottom surface, the top surface, or extends through both the bottom and top surfaces, to facilitate a connection between the wire housing box and another external structure.

11. (canceled)

12. (canceled)

13. (canceled)
